(19) United States
(12) Patent Application Publication
(10) Pub. No.: US 2008/0259604 A1
(43) Pub. Date: Oct. 23, 2008

(54) Safety detachable lamp assembly

(76) Inventor: Tzi-Chen Huang, Taoyan Hsien (TW)

Correspondence Address: TZI-CHEN HUANG, 235 Chung-Ho, Box 8-24, Taipei, TW

(21) Appl. No.: 11/787,673

(22) Filed: Apr. 18, 2007

(51) Int. Cl. F21V 17/00; F21V 23/04

(52) U.S. Cl. 362/251; 362/375

(57) ABSTRACT

A detachable lamp assembly comprises a joint installed to an electric wire; one end of the joint having insertion holes; two sides of the insertion holes being formed with respective buckling grooves; a lamp body having a bulb therein; a periphery of the bulb being formed with a frame, a bottom end of the bulb being formed with a plug; two sides of the plug have respective buckle units; a lateral side of the lamp body having a switch and a receptacle with a plurality of receptacle holes; and two buckle units; each buckle being movably installed to the lamp body; a front end of each buckle unit having a buckle; when the buckle unit being combined to the buckling groove of the joint; and the buckle serving to fix the buckle unit to the joint.

### FIELD OF THE INVENTION

The present invention relates to lamps, and particularly to a safety detachable lamp assembly, which can provide illumination in a large area, such as working fields, squares, and night markets. Moreover, the lamp assembly is used safely and can be assembled and detached easily and conveniently.

### BACKGROUND OF THE INVENTION

In some fields, such as building sites, squares, or night markets without illumination devices, a simple way of serially connecting a plurality of bulbs is used for providing illumination.

Referring to FIG. 1, a prior art serial lamp assembly is illustrated. A plurality of bulbs are serially connected through a power wire. The structure is simple. However in this prior art arrangement, the power wire and bulbs are exposed out. The structure is not concrete. Moreover, a slender power wire is not sufficient to support the bulbs so that it is possible that the power wire is broken and the bulbs fall down. As a result, some dangerous accidents will occur.

Furthermore, if the bulbs are necessary to be updated, the hand will hold the seat of the bulb for detaching the bulb. It is possible that the hand will touch the power wire carelessly so as to get electric shock, or the hand is burnt by the high temperature of the bulb.

### SUMMARY OF THE INVENTION

Accordingly, the primary object of the present invention is to provide a safety detachable lamp assembly, which can provide illumination in a large area, such as working cites, squares, and night markets. Moreover, the lamp assembly is used safely and can be assembled and detached easily and conveniently.

To achieve above objects, the present invention provides detachable lamp assembly, comprising a joint installed to an electric wire; one end of the joint having insertion holes; two sides of the insertion holes being formed with respective buckling grooves; a lamp body having a bulb therein; a periphery of the bulb being formed with a frame, a bottom end of the bulb being formed with a plug; two sides of the plug have respective buckle units; a lateral side of the lamp body having a switch and a receptacle with a plurality of receptacle holes; and two buckle units; each buckle being movably installed to the lamp body; a front end of each buckle unit having a buckle; when the buckle unit being combined to the buckling groove of the joint; the buckle serving to fix the buckle unit to the joint.

In assembly, the plug of the lamp body inserted into the receptacle and the buckles are buckled into the buckling grooves so as to retain the lamp body to the joint.

A power wire passes through the joint for retaining the lamp body to the joint and thus a plurality of lamp body can be retained to the power wire.

A surface of the switch is installed with a switch cover for dust proof, wet proof and protection of the switch.

When the lamp body is inserted to the insertion holes of the joint and power is supplied, the bulb will light up.

The various objects and advantages of the present invention will be more readily understood from the following detailed description when read in conjunction with the appended drawing.

### BRIEF DESCRIPTION OF THE DRAWINGS

FIG. 1 is a schematic view of a prior art lamp.

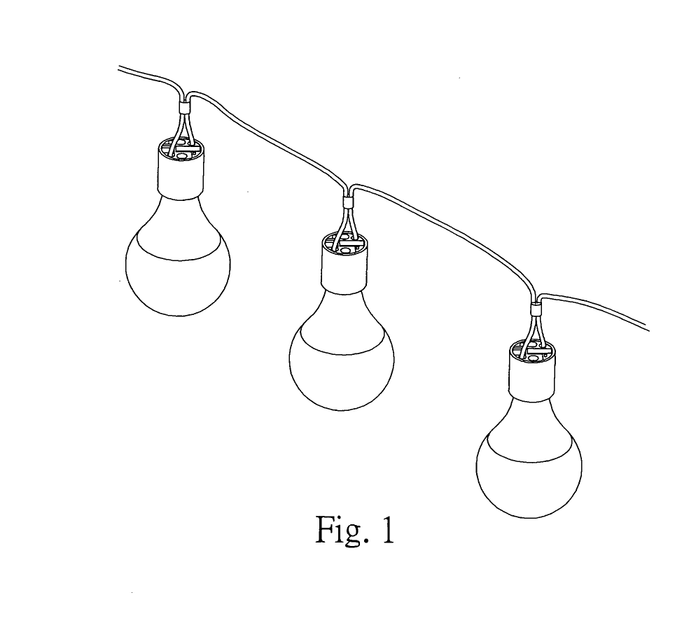

FIG. 2 is an exploded perspective view of the present invention.

FIG. 3 is a schematic view showing the assembly work of the present invention.

FIG. 4 is an assembled view of the present invention.

FIG. 5 is a cross sectional view about the assembly of the present invention.

FIG. 6 is a schematic view showing another assembly view of the present invention.

FIG. 7 is shows one application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

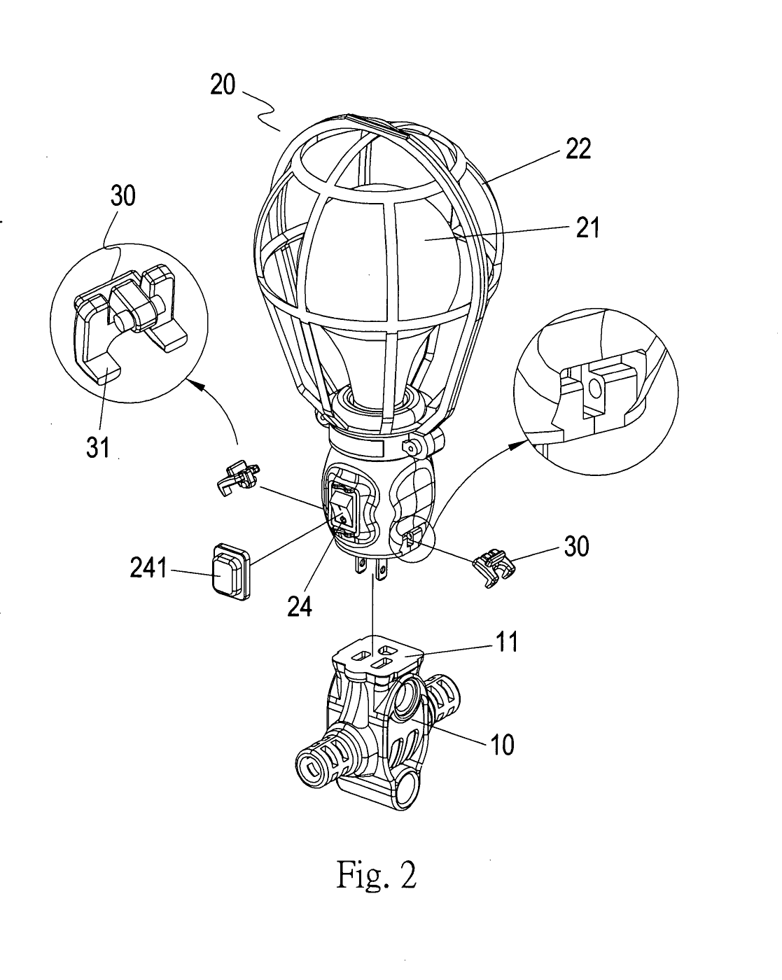

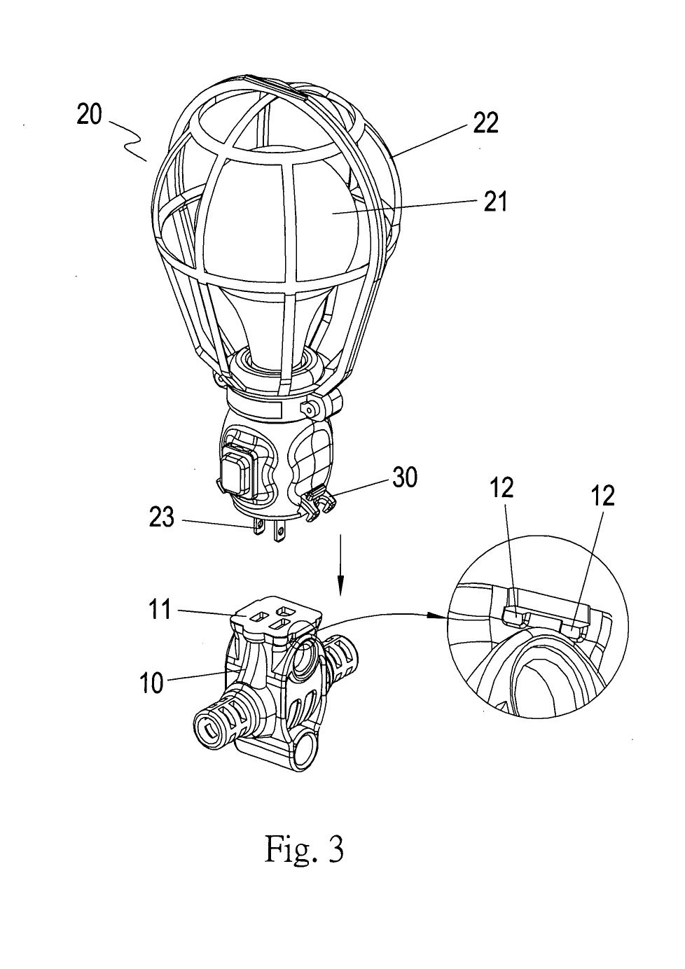

Referring to FIGS. 2 and 3, the separable lamp assembly of the present invention is illustrated. The present invention has the following elements:

A joint 10 is installed to an electric wire. One end of the joint 10 has insertion holes 11. Two sides of the insertion holes 11 are formed with respective buckling grooves 12.

A lamp body 20 has a bulb 21 therein. A periphery of the bulb 21 is formed with a frame 22. Furthermore, a bottom end of the bulb 21 is formed with a plug 23. Two sides of the plug 23 have respective buckle units 30. A lateral side of the lamp body 20 has a switch 24 and a receptacle 25 with a plurality of receptacle holes.

Two buckle units 30 are included. Each buckle 30 is movably installed to the lamp body 20. A front end of each buckle unit 30 has a buckle 31. When the buckle unit 30 is combined to the buckling groove 12 of the joint 10, the buckle 31 serves to fix the buckle unit 30 to the joint 10.

Referring to FIG. 3, the combination of the present invention is illustrated. In assembly, the plug 23 of the lamp body 20 inserts into the insertion holes 11. The buckle units 30 are buckled to the buckling grooves 12 so that the lamp body 20 is firmly secured to the joint 10. The buckles 31 at two sides of the lamp body 20 are driven to move downwards and the buckles 31 are fixed to the buckling grooves 12 so as to complete the assembly work.

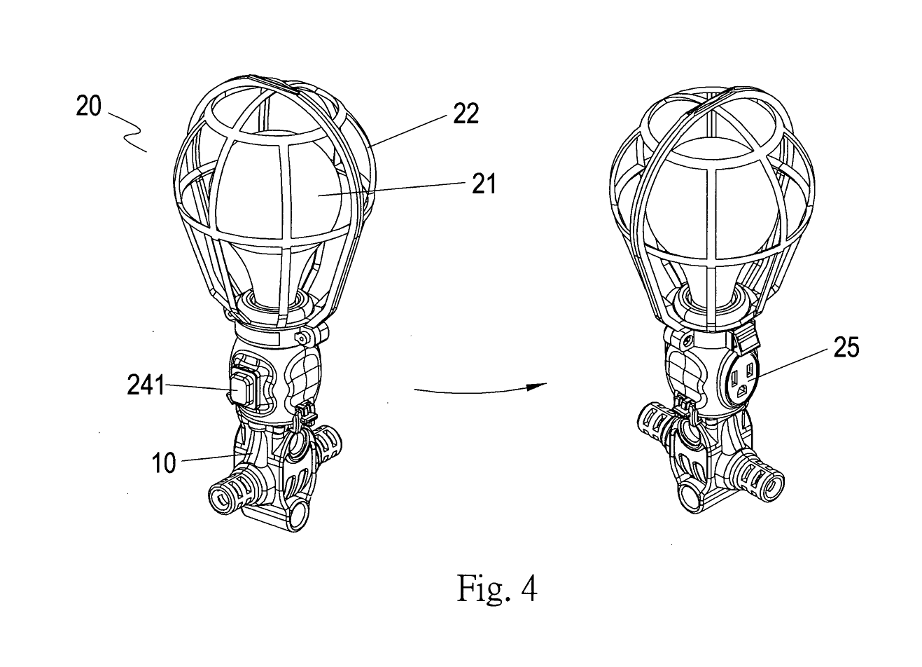

Referring to FIG. 4, the assembled perspective view of the present invention is illustrated. After assembly, a periphery of the bulb 21 is enclosed by the frame 22. A lateral side of the lamp body 20 is installed with the switch 24 and receptacle 25 which are arranged at two opposite sides. A surface of the switch 24 is installed with a switch cover 241 for dust proof, wet proof and protection of the switch. The switch 24 serves for actuating the bulb 21.

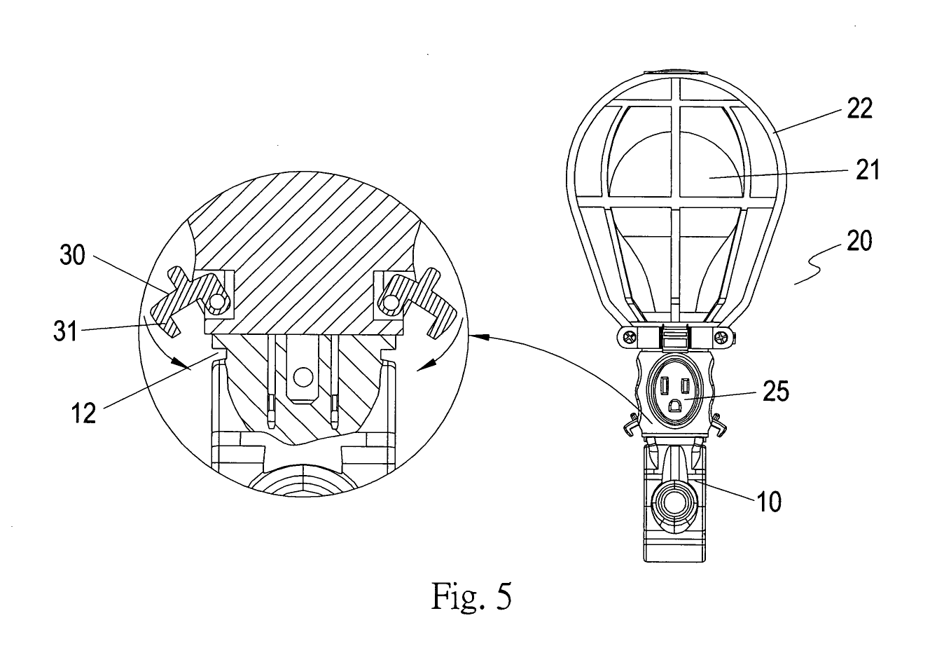

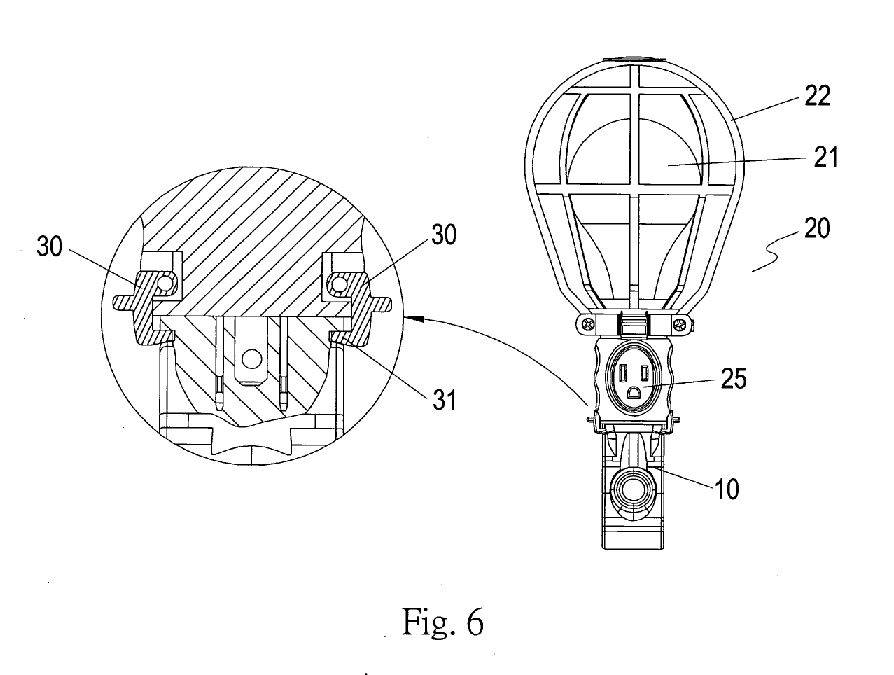

Referring to FIGS. 5 and 6, the cross sectional view of the present invention is illustrated. It is illustrated that the lamp body 20 has been inserted into the joint 10. The buckles 31 of the buckle units 30 are retained to the buckling grooves 12 so as to fix the lamp body 20 to the joint 10. When it is desired to draw the lamp body 20 from the joint 10, it is only necessary to move the two buckles 31 outwards and then the bulb 21 can be taken out from the joint 10.

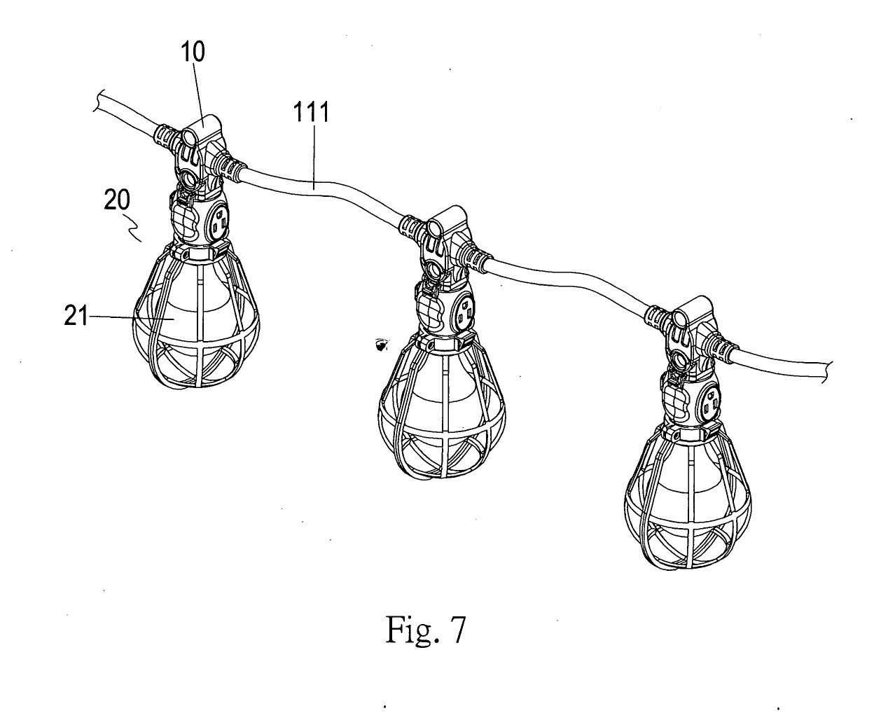

Referring to FIG. 7, one application of the present invention is illustrated. A power wire 111 passes through a plurality of joints 10 so as to serially connect a plurality of bulbs 21 to the power wire 111. Each bulb 21 has the receptacle 25 for turning on of the lamp body 20.

Advantages of the present invention are that the lateral side of the lamp body 20 has the switch 24 and receptacle 25. A surface of the switch 24 has a switch cover 241 for dust proof, wet proof and protection.

Furthermore, the assembly work can be performed rapidly and easily by buckling the buckles 31 of the buckle units 30 to the buckling grooves 12 of the joint 10, that the lamp body 20 can be firmly secured to the joint 10.

Moreover, the lamp body 20 can be easily detached from the joint 10 by unbuckling the buckles 31 from the buckling grooves 12 of the joint 10.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A detachable lamp assembly, comprising:
a joint installed to an electric wire; one end of the joint having insertion holes; two sides of the insertion holes being formed with respective buckling grooves;
a lamp body having a bulb therein; a periphery of the bulb being formed with a frame, a bottom end of the bulb being formed with a plug;
two sides of the plug have respective buckle units; a lateral side of the lamp body having a switch and a receptacle with a plurality of receptacle holes; and
two buckle units; each buckle being movably installed to the lamp body; a front end of each buckle unit having a buckle; when the buckle unit being combined to the buckling groove of the joint; the buckle serving to fix the buckle unit to the joint.

2. The detachable lamp assembly as claimed in claim 1, wherein in assembly, the plug of the lamp body inserted into the receptacle and the buckles are buckled into the buckling grooves so as to retain the lamp body to the joint.

3. The detachable lamp assembly as claimed in claim 1, wherein a power wire passes through the joint for retaining the lamp body to the joint and thus a plurality of lamp bodies can be retained to the power wire.

4. The detachable lamp assembly as claimed in claim 1, wherein a surface of the switch is installed with a switch cover for dust proof, wet proof and protection of the switch.

5. The detachable lamp assembly as claimed in claim 1, wherein when the lamp body is inserted to the insertion holes of the joint and power is supplied, the bulb will light up.
